(19) United States
(12) Patent Application Publication
(10) Pub. No.: US 2003/0151251 A1
(43) Pub. Date: Aug. 14, 2003

(54) Furnace pipe connection

(75) Inventor: Dalton B. Barnoff, Senneville (CA)

Correspondence Address: Ogilvy Renault, Suite 1600, 1981 McGill College Avenue, Montreal, QC, H3A 2Y3, CA

(73) Assignee: Trans Continental Equipment Ltd., Montreal (CA)

(21) Appl. No.: 10/073,169

(22) Filed: Feb. 13, 2002

(51) Int. Cl. F16L 3/00

(52) U.S. Cl. 285/123.15; 285/361

(57) ABSTRACT

The present invention relates to a pipe connection configuration which is particularly used for furnace exhaust pipe connection or the like. A sheet metal pipe with an open end thereof is mounted to a sheet metal T-shaped three-way pipe joint. The pipe joint has a first pipe section and a second pipe section extending perpendicularly from the first pipe section. The pipe joint includes a pair of diametrically opposed bayonet slots extending from an open end of the second pipe section for receiving and engaging a pair of diametrically opposed pins projecting radially and outwardly from the pipe when the open end of the pipe slides into the open end of the second pipe section, in order to ensure a secure connection between the pipe and the pipe joint. Such a pipe connection configuration provides a self-locking connection of the pipe to the T-shaped three-way pipe joint in a very simple manner which reduces the amount of labour required on site.

### THE FIELD OF THE INVENTION

The present invention relates to a method of connecting a sheet metal pipe to a sheet metal T-shaped three-way pipe joint, particularly used in furnace exhaust pipe connection and heated air pipe connection.

### BACKGROUND OF THE INVENTION

In a furnace exhaust pipe connection or heated air pipe connection, a sheet metal pipe sometimes needs to be connected to a sheet metal T-shaped three-way pipe joint. The T-shaped three-way pipe joint includes a first pipe section extending in one direction and a second pipe section extending in a perpendicular direction from the first pipe section. The second pipe section of the T-shaped three-way pipe joint is usually very short and with an open end for receiving an open end of the pipe through sliding fits. As shown in FIGS. 1a and 1b which are the respective partial side view and partial top plan view of the T-shaped three-way pipe joint and the pipe to be connected together, the open end of the pipe 10 includes a pair of diametrically opposed pointed snout sections 12 projecting axially and outwardly from the open end of the pipe. The pointed snout sections will increase the contact surfaces while not creating a flow obstacle in the first pipe section 14 of the T-shaped three-way pipe joint 16 when the open end of the pipe 10 is inserted into the open end of the second pipe section 18. Additional securing means are often used, such as a metal strip (not shown), to secure the connection of the pipe 10 and the pipe joint 16 which makes the site installation more time consuming and thereby increases costs.

It would therefore be highly desirable to provide a more simple method of self-locking connection of a sheet metal pipe to a sheet metal T-shaped three-way pipe joint.

### SUMMARY OF THE INVENTION

One object of the present invention is to provide a method of self-locking connection of a sheet metal pipe to a sheet metal T-shaped three-way pipe joint in a simple manner.

In accordance with one aspect of the present invention, there is provided a method of connecting a sheet metal pipe to a sheet metal T-shaped three-way pipe joint having a first pipe section and a second pipe section extending perpendicularly from the first pipe section. The method comprises making a bayonet slot in the second pipe section of the pipe joint; securing a pin to the pipe, the pin projecting radially and outwardly from the pipe and being adjacent to an open end thereof; and sliding the open end of the pipe into an open end of the second pipe section to engage the pin in the bayonet slot thereby locking the pipe in position relative to the pipe joint.

In accordance with another aspect of the present invention there is provided a pipe connection configuration comprising a sheet metal pipe with an open end thereof, and a sheet metal T-shaped three-way pipe joint having a first pipe section and a second pipe section extending perpendicularly from the first pipe section. The pipe joint includes a bayonet slot extending from an open end of the second pipe section for receiving and engaging a pin projecting radially and outwardly from the pipe when the open end of the pipe slides into the open end of the second pipe section, to ensure a secure connection between the pipe and the pipe joint.

The bayonet slot according to one embodiment of the present invention comprises an engaging section extending axially and inwardly from the open end of the second pipe section and a locking section extending from an inner end of the engaging section. The locking section is perpendicular to the engaging section. The open end of the pipe is preferably flat with a truncated conical end section which is adapted to be inserted into the open end of the second pipe section. Alternatively, the flat open end of the pipe includes a crimped end section which is adapted to be inserted into the open end of the second pipe section.

The open end according to a further embodiment of the present invention optionally includes a pair of diametrically opposed pointed snout sections projecting axially and outwardly from the open end of the pipe to increase the contact surface between the pipe and the pipe joint.

The present invention provides a simple method of securing a pipe connection to a T-shaped three-way pipe joint thereby reducing the labour required on site and therefore reducing the cost of installation of a furnace pipe system.

### BRIEF DESCRIPTION OF THE DRAWINGS

Having thus generally described the nature of the invention, reference will now be made to the accompanying drawings, showing by way of illustration, preferred embodiments thereof, in which:

FIG. 1a is a partial side view of a pipe and a T-shaped three-way pipe joint to be connected together using a conventional method;

FIG. 1b is a top plan view of FIG. 1a, showing particularly a pair of pointed snout sections of the pipe;

FIG. 2 is a partial side view of a pipe and a T-shaped three-way pipe joint to be connected together according to one embodiment of the present invention;

FIG. 3 is a partial side view of a pipe and a T-shaped three-way pipe joint to be connected together according to another embodiment of the present invention;

FIG. 4 is a partial side view of a pipe and a T-shaped three-way pipe joint to be connected together according to a further embodiment of the present invention; and

FIG. 5 is a view similar to FIG. 4 with alternative positions of the lock pin and the bayonet slot.

### DETAILED DESCRIPTION OF THE EMBODIMENTS

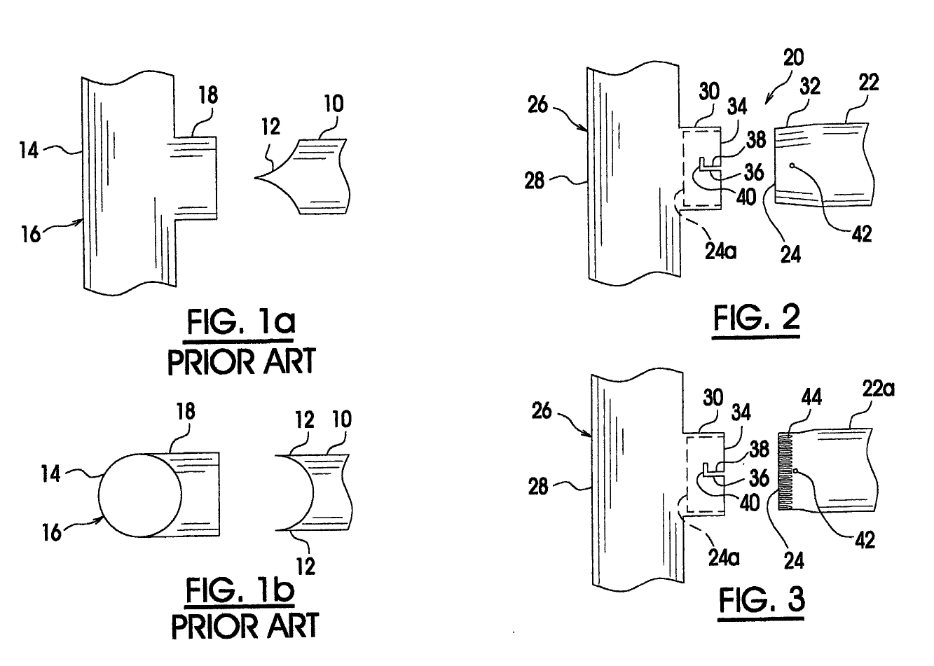

As may be seen in FIG. 2, the pipe connection configuration of the present invention, identified with reference numeral 20, includes a sheet metal pipe 22 with an open end 24 and a sheet metal T-shaped three-way pipe joint 26 which has a first pipe section 28 extending in one direction and a second pipe section 30 extending from the first pipe section 28 in another direction perpendicular to the first pipe section 28. The pipe 22 is a part of an upstream section of a fluid flow system such as an exhaust pipe or hot air duct from a furnace. The T-shaped three-way pipe joint 26 is a part of a downstream section of the fluid flow system, such as a chimney or a downstream hot air duct. The first pipe section 28 and the second pipe section 30 of the pipe joint 26 have a substantially equal diameter. The pipe 22 has a substantially equal diameter with respect to the pipe joint 26. However, the pipe 22 is either slightly tapered along its entire section or includes a truncated conical end section 32 which is exaggerated in FIG. 2 for a better illustration, such that the open end 24 of the pipe 22 is slightly smaller than an open end 34 of the second pipe section 30 to ensure sliding fits of the pipe 22 into the second pipe section 30 of the pipe joint 26.

The second pipe section 30 is relatively short and provides a limited contact surface when the open end 24 of the pipe 22 is inserted into the second pipe section 30 through the open end 34 thereof, particularly when the pipe 22 has a flat type of open end 24. In order to ensure a secure connection, it is therefore necessary to provide securing means between the pipe 22 and the pipe joint 26. For this purpose, a pair of bayonet slots 36 are provided on the second pipe section 30 of the pipe joint 26 which are diametrically opposed and only one of which is shown in FIG. 2. The bayonet slot 36 is in an L-shape and includes an engaging section 38 extending axially and inwardly from the open end 34 of the second pipe section 30, and a locking section 40 extending circumferentially from an inner end of the engaging section 38. It is noted that the locking sections 40 of both diametrically opposed bayonet slots 36 extend forwardly from the respective engaging sections 38 in the same circumferential direction.

A pair of diametrically opposed pins 42 are accordingly provided on the pipe 22, adjacent to the open end 24 (only one pin is shown). The pins 42 project radially and outwardly from the pipe 22 in opposite directions, and are adapted to be received in the respective bayonet slots 36.

In the pipe installation operation, the pair of pins 42 are aligned with the respective bayonet slots 36 when the pipe 22 is lined up with the second pipe section 30 of the pipe joint 26. The pipe 22 is then mounted to the pipe joint 26 by sliding the truncated conical end section 32 of the pipe 22 into the open end 34 of the second pipe section 30 while the pins 42 slide along the respective engaging section 38 of the bayonet slots 36 to their inner end. The pipe 22 is then rotated to lock the pins 42 into the respective locking sections 40 of the bayonet slots 36 such that the pipe 22 is securely connected to the second pipe section 30 of the pipe joint 26.

It is noted that the length of the engaging sections 38 of the bayonet slots 36 and the distance between the open end 24 and the pins 42 are properly determined such that when the pins 42 are locked in the locking sections 40 of the bayonet slots 36 the open end 24 of the pipe 22 will not project into the first pipe section 28 to create an obstacle to fluid flow in the first pipe section 28 of the pipe joint 26. The broken line 24a shows an appropriate position of the open end 24 of the pipe 22 when the pipe 22 is securely connected to the pipe joint 26.

FIG. 3 illustrates another embodiment of the present invention in which like components, as shown in FIG. 2 are indicated by like numerals and will not be redundantly described. In this embodiment, the T-shaped three-way pipe joint 26 is the same as that of the embodiment shown in FIG. 2. The pipe 22a, similarly to pipe 22 in FIG. 2, has a flat open end 24. However, in contrast to the truncated conical end section 32 of the pipe 22, the pipe 22a has a crimped end section 44. The crimped deformation of a pipe wall at the open end 24 reduces the diameter of the pipe 22a at the open end 24 so that the crimped end section 44 properly guides the insertion of the pipe 22a into the second pipe section 30 of the pipe joint 26 when sliding the pipe 22a into the second pipe section 30. The pipe 22a also includes a pair of diametrically opposed pins 42 for locking into the bayonet slots 36 of the pipe joint 26.

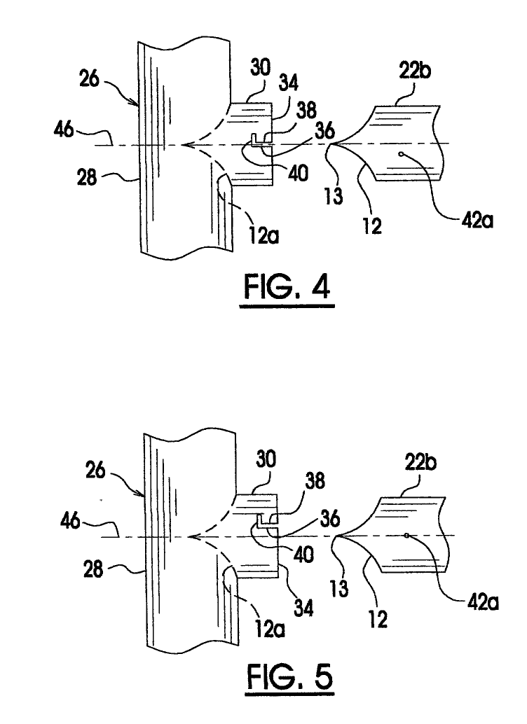

FIGS. 4 and 5 illustrate a further embodiment of the present invention in which like components as shown in FIG. 2 are indicated by like numerals and will not be redundantly described. The T-shaped three-way pipe joint 26 is the same as that of the embodiment shown in FIG. 2. The pipe 22b in contrast to the flat ended pipe 22 in FIG. 2, has an open end with a pair of diametrically opposed pointed snout sections 12 which are similar to those shown in FIGS. 1a and 1b. The pipe 22b is preferably slightly tapered along its entire length so that the open end with the pointed sections 12 of the pipe 22b has a diameter slightly smaller than the inner diameter of the second pipe section 30 of the pipe joint 26 to facilitate the insertion of the pipe 22b into the second pipe section 30. As more clearly shown in FIG. 1b, the diametrically opposed pointed snout sections 12 in a top plan view define a semi-circular cross-sectional space. Thus, the two pointed snout sections 12 will make close contact with the pipe wall of the first pipe section 28 without creating an obstacle to fluid flow in the first pipe section 28 when the pipe 22b is mounted to the second pipe section 30 of the pipe joint 26 and the pointed snout sections 12 project into the first pipe section 28 as shown by broken lines 12a.

In contrast to the embodiments shown in FIGS. 2 and 3 in which there is no particular circumferential position restriction to the pins 42 with respect to the pipe 22, the pipe 22b must be mounted to the pipe joint 26 with the two tip points 13 (only one is shown in FIGS. 4 and 5) disposed in a plane which is perpendicular to the first pipe section 28 and diametrically intersects the second pipe section 30, as indicated by line 46. Thus, the appropriate connection position shown by the broken line 12a is ensured. For this purpose, the diametrically opposed pins 42a on the pipe 22b must be circumferentially offset from the respective tip points 13 in a direction and a length corresponding to the locking section 40 of the bayonet slots 36 on the second pipe section 30, as shown in FIG. 4.

When the pipe 22b is inserted into the second pipe section 30 of the pipe joint 26, the pins 42a are aligned with the respective engaging sections 38 of the bayonet slots 36 while the tip points 13 are circumferentially offset from the plane 46. After the pins 42a reach the inner end of the respective engaging sections 38 of the bayonet slots 36, the pipe 22b is rotated to lock the pins 42a into the respective locking sections 40 of the bayonet slots 36, thus the pipe 22b is properly connected to the pipe joint 26 as shown by the broken line 12a.

It is also noted that the axial distance from the pins 42a to the respective tip points 13 and the length of the engaging section 38 of the bayonet slots 36 are properly determined to ensure the appropriate connection position as shown by the broken line 12a.

Alternatively, as shown in FIG. 5, the pair of diametrically opposed pins 42a on the pipe 22b are circumferentially aligned with the respective tip points 13 of the pointed snout sections 12, while the pair of diametrically opposed bayonet slots 36 are circumferentially offset such that the respective locking sections 40 of the bayonet slots 36 terminate at a place a little over the plane 46. With such an alternative arrangement, the pipe 22b will also be mounted to the pipe joint 26 in the appropriate position indicated by broken line 12a.

While the invention has been described with particular reference to the illustrated embodiments, it will be understood that numerous modifications thereto may be apparent to those skilled in the art. Accordingly, the above description and accompanying drawings should be taken as illustrative of the invention and not in a limiting sense.

We claim:

1. A method of connecting a sheet metal pipe to a sheet metal T-shaped three-way pipe joint having a first pipe section and a second pipe section extending perpendicularly from the first pipe section, comprising:
making a bayonet slot in the second pipe section of the pipe joint;
securing a pin to the pipe, the pin projecting radially and outwardly from the pipe and being adjacent to an open end thereof; and
sliding the open end of the pipe into an open end of the second pipe section to engage the pin in the bayonet slot thereby locking the pipe in position relative to the pipe joint.

2. A method as claimed in claim 1 wherein the bayonet slot comprising an engaging section extending axially and inwardly from the open end of the second pipe section and a locking section extending circumferentially from an inner end of the engaging section.

3. A method as claimed in claim 2 wherein the open end of the pipe is flat.

4. A method as claimed in claim 2 wherein the open end of the pipe includes a truncated conical end section adapted to be inserted into the open end of the second pipe section.

5. A method as claimed in claim 2 wherein the open end of the pipe includes a crimped end section adapted to be inserted into the open end of the second pipe section.

6. A pipe connection configuration comprising a sheet metal pipe with an open end thereof, and a sheet metal T-shaped three-way pipe joint having a first pipe section and a second pipe section extending perpendicularly from the first pipe section, the pipe joint including a bayonet slot extending from an open end of the second pipe section for receiving and engaging a pin projecting radially and outwardly from the pipe when the open end of the pipe slides into the open end of the second pipe section, to ensure a secure connection between the pipe and the pipe joint.

7. A pipe connection configuration as claimed in claim 6 wherein the bayonet slot comprising an engaging section extending axially and inwardly from the open end of the second pipe section and a locking section extending circumferentially from an inner end of the engaging section.

8. A pipe connection configuration as claimed in claim 7 wherein the open end of the pipe is flat.

9. A pipe connection configuration as claimed in claim 8 wherein the open end of the pipe includes a truncated conical end section adapted to be inserted into the open end of the second pipe section.

10. A pipe connection configuration as claimed in claim 8 wherein the open end of the pipe includes a crimped end section adapted to be inserted into the open end of the second pipe section.

11. A pipe connection configuration as claimed in claim 7 wherein the open end of the pipe comprises a pair of diametrically opposed pointed snout sections projecting axially and outwardly from the open end of the pipe.

12. A pipe connection configuration as claimed in claim 11 wherein the pin is circumferentially offset from a tip point of one of the pointed snout sections, and wherein the engaging section of the bayonet slot is disposed in a plane which diametrically intersects the second pipe section and is perpendicular to the first pipe section.

13. A pipe connection configuration as claimed in claim 11 wherein the pin is circumferentially aligned with a tip point of one of the pointed snout sections, and wherein the engaging section of the bayonet slot is circumferentially offset from a plane which diametrically intersects the second pipe section and is perpendicular to the first pipe section.
